(19) United States
(12) Patent Application Publication
(10) Pub. No.: US 2025/0092957 A1
(43) Pub. Date: Mar. 20, 2025

(54) SHAPE MEMORY ALLOY PRODUCTS

(71) Applicant: KOHLER CO., Kohler, WI (US)

(72) Inventors: Andrew Smith, Sheboygan, WI (US); Clay Garrels, Sheboygan, WI (US); Lawrence Grin, Fond Du Lac, WI (US); Niels Eilmus, Sheboygan, WI (US); Michael Smith, Plymouth, WI (US); William Kuru, Plymouth, WI (US); Jason Kwacz, Kohler, WI (US)

(21) Appl. No.: 18/888,948

(22) Filed: Sep. 18, 2024

Related U.S. Application Data
(60) Provisional application No. 63/583,458, filed on Sep. 18, 2023.

(51) Int. Cl. F16K 31/02; A47K 13/10; E03D 9/08; F03G 7/06; F16K 31/00; G05D 3/10

(52) U.S. Cl. CPC F16K 31/025; A47K 13/10; E03D 9/08; F03G 7/0614; F16K 31/002; G05D 3/10

(57) ABSTRACT

Shape memory alloys (“SMAs”) may be used within and for many different contexts. The unique structure and makeup of SMAs may be more efficient and effective than existing solutions and may provide more advantageous benefits. For example, SMAs may be used to control direction and flow of water in bathing appliances. As another example, SMAs may be used to control the positioning of water outlets or different fixtures. SMAs may be used to control and adjust bathing products, which may further enhance user experience when handling such products.

### CROSS-REFERENCE TO RELATED APPLICATION

The present application claims priority to U.S. Provisional Patent Application No. 63/583,458, filed Sep. 18, 2023, entitled, “SHAPE MEMORY ALLOY PRODUCTS,” the entire contents of which are hereby incorporated by reference.

### BACKGROUND

Standard bathroom fixtures and appliances require an individual to manually move or adjust the fixtures and appliances. For example, an individual may manually move a showerhead when it is warming up so as to not feel cold water. As another example, an individual may manually lift a toilet seat or adjust the positioning of a bathroom faucet. Such individuals may prefer fixtures and appliances that do not require manual movement or adjustment, but rather, include forms of automatic movement or adjustment.

### BRIEF DESCRIPTION OF DRAWINGS

FIGS. 1 and 2 include various explanatory views of the process by which shape memory alloys (“SMAs”) transition between states.

FIGS. 3-6 include various views of examples of SMAs in use with faucets.

FIGS. 7 and 8 include various views of examples of SMAs in use with showers.

FIGS. 9-28 include various views of examples of SMAs in use with toilets.

FIGS. 29-32 include various views of examples of SMAs in use with bidets.

FIGS. 33-36 include various views of example SMA valves.

FIGS. 37-42 include various views of examples of SMAs in use with locking and latching assemblies.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

Shape memory alloys (“SMAs”) may be used to achieve a non-manual or automatic movement or adjustment of fixtures and appliances. SMAs have many properties that may be useful for such use, including their strength and flexibility. SMAs may be adjusted based on a change in temperature or by use of an electrical current. As a non-limiting example, voltages of between 3V to 12V may be applied to SMAs to achieve actuation. Any form of SMAs may be used in the manner as described herein. As one example, nitinol, a type of SMA, may be used. Nitinol may be corrosion resistant, which may be particularly relevant when used in certain fixtures. However, other formulations of alloys that have shape memory characteristics may be used, including shape memory polymers or shape memory plastics (each referred to as “SMPs”). The term “SMAs” may be used herein to refer to SMAs and SMPs. SMAs may be used in addition to or in place of solenoids.

One benefit for using SMAs is that they may be adjusted between pre-programmed states using no additional energy or using very little energy. For example, if sufficiently hot water reaches an SMA, no additional energy other than the energy in the hot water may be needed to adjust the position or shape of the SMA. In some embodiments, hot water with a temperature between 100-140 degrees Fahrenheit may be sufficient to change states of the SMAs. Another benefit is that SMAs are relatively inexpensive, as compared to other actuation devices (e.g., motors and solenoids). SMAs may take a variety of different forms, including, but not limited to, rods, coils, wires, springs, plates, foils, sheets, extrusions, stampings, mesh, and any other shapes or forms now known or hereafter developed. As stated, SMAs may take the form as SMA sheets. The SMA sheets may be any shape and may be stamped to form any desired shape. The SMA sheets may be thin and may be referred to as a foil or a film. The SMA sheets, which may be stamped, may be coated in a sealant or a flexible membrane. This membrane may be configured to make a diaphragm that opens and closes a flow path for fluidic devices. This membrane may be configured to create a pump. An SMA wire, rod, or coil may be formed into a flexible diaphragm to create a pump.

The functions of SMAs are achieved using their internal molecular structure. SMAs may adjust from a Martensite state to an Austenite state depending on the temperature or applied electrical current. In a Martensite state, the material of SMAs may be flexible and/or pliable. In an Austenite state, the material of SMAs may be more rigid. SMAs may be able to take on these transformations several times and partake in repeated cycles transitioning from a Martensite state to an Austenite state. SMAs may be programmed to take shapes in both a Martensite state and an Austenite state. Transitions may be achieved depending on a temperature applied to SMAs.

The SMAs as described herein may be one-way or two-way SMAs. A one-way SMA may transition to a memory state or memory shape when it reaches a desired temperature. As one example, a one-way SMA may transition to a memory state or memory shape when heated. A one-way SMA may not return to its original shape when cooled. Using a one-way SMA may require an external force to return the SMA to its original shape. A two-way SMA may transition to a memory state or memory shape when it reaches a desired temperature. As one example, a two-way SMA may transition to a memory state or memory shape when heated. A two-way SMA may return to its original shape when cooled. Using a two-way SMA may not require an external force to return the SMA to its original shape.

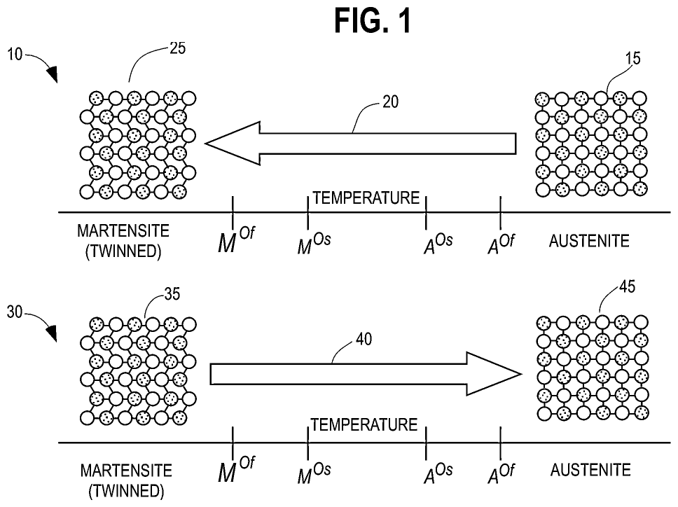

In FIG. 1, according to transition 10, an example SMA may start out in an Austenite state 15. When adjusting from a cool temperature or a warm temperature at step 20, the SMA may end in a Martensite state 25. According to transition 30, an example SMA may start out in a Martensite state 35. When adjusting from a cool temperature or a warm temperature at step 40, the SMA may end in an Austenite state 45.

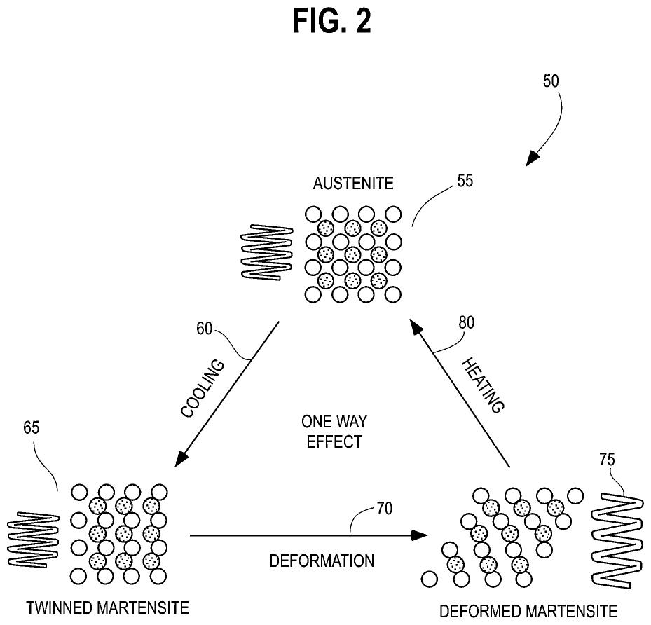

In FIG. 2, transition 50 may occur to transition an example SMA from one state to another. Transition 50 may be cyclical, and the SMA may start out and/or end up in various states, depending on where the SMA is within the cycle. An SMA may transition from an Austenite state 55 via cooling at step 60 into a twined Martensite state 65. The SMA in state 65 may then transition via deformation at step 70 into a deformed Martensite state 75. Heat may be applied at step 80 to transition the deformed Martensite state 75 to the Austenite state 55.

SMAs described herein may be used to actuate a plumbing fixture. SMAs may be trained to react or activate to a specific set of temperatures, and such set of temperatures may only differ slightly. For example, an SMA may be configured to change forms when water warms or cools to reach a predetermined temperature (e.g., above or below 104 degrees Fahrenheit). SMAs may be trained to adjust at any temperature, including room temperature. SMAs may alternatively or additionally be configured to adjust based on an electrical current, a battery, or otherwise; this may be particularly useful when fixtures do not have any water connections.

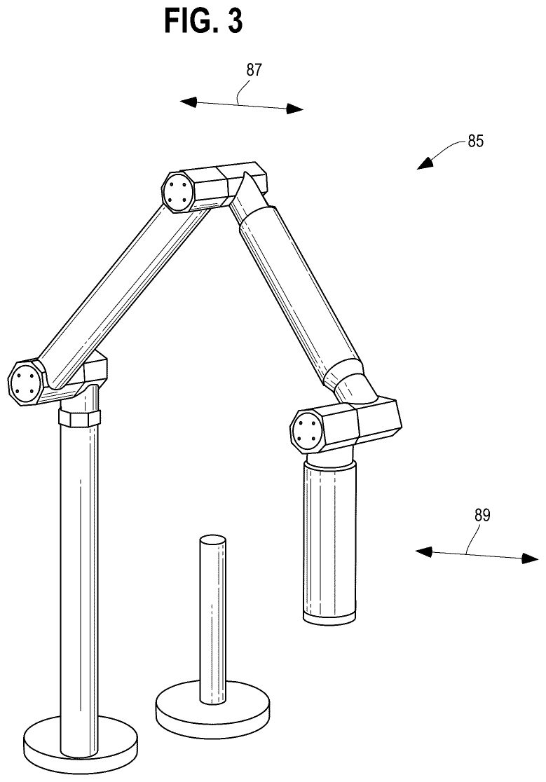

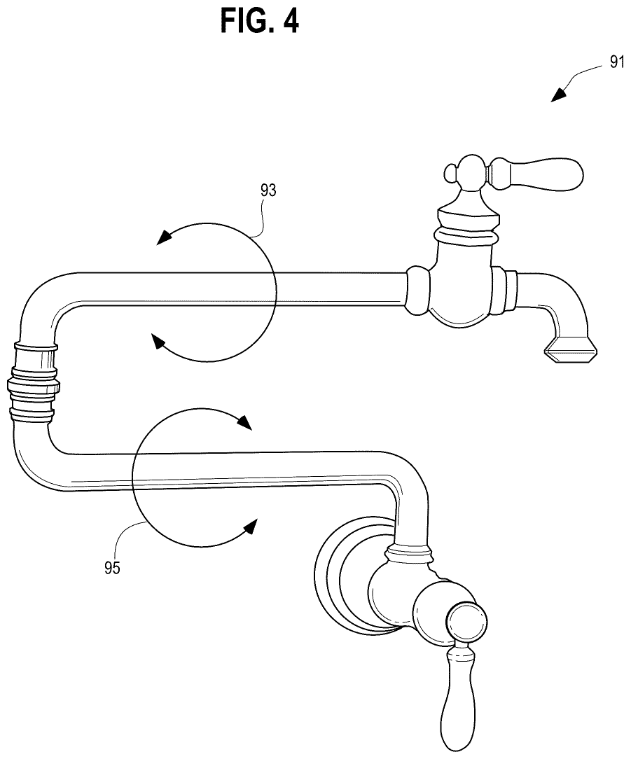

According to FIG. 3, SMAs may be used to adjust or actuate a faucet 85. Movement may occur as shown at 87 and/or 89, and such movement may be achieved based on a change in the temperature of a water input, or based on the application of electricity. A water input may be adjusted from hot to cold or from cold to hot, and such adjustment may actuate movement of the faucet 85. One or more SMAs within the faucet 85 may cause the faucet 85 to extend or retract outwardly at 87 and/or 89 when water warms from cold and may retract inward at 87 and/or 89 when water cools from hot, or vice versa. The actuation at 87 and 89 may be rotational and/or linear. In FIG. 4, SMAs may be used to adjust the position of a faucet 91. Movement may occur as shown at 93 and/or 95, and such movement may be achieved based on a change in the temperature of a water input or based on the application of electricity. A water input may be adjusted from hot to cold or from cold to hot, and such adjustment may actuate the position of the faucet 91. SMAs within the faucet 91 may cause the faucet 91 to extend outward at 93 and/or 95 when water warms from cold and may retract inward at 93 and/or 95 when water cools from hot, or vice versa. The rotation at 93 and 95 may be rotational and/or linear.

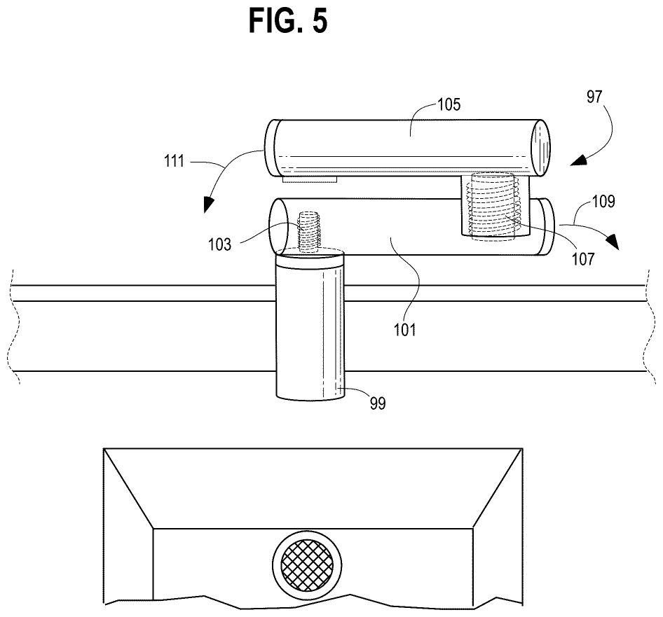

According to FIG. 5, the faucet 97 may include a base 99 attached to a first portion 101, and such attachment may include an SMA spring 103. The first portion 101 may be attached to a second portion 105, and such attachment may include an SMA spring 107. SMA spring 103 may cause the first portion 101 to rotate in the direction as shown by arrow 109. SMA spring 107 may cause the second portion 105 to rotate in the direction as shown by arrow 111. One or both of SMA springs 103 and 105 may be activated at once. The faucet 97 may be adjusted to various different configurations such that the base 99, first portion 101, and second portion 105 are in different positions with respect to one another. The SMA springs 103, 105, 107 may be activated independently or with one another, which may cause adjustment and/or articulation of the components of the faucet 97. The articulation may be used to adjust the components into a “hidden pocket,” such that the components may be retracted, out of view, and/or hidden when not in use. Adjustment may be caused by the SMA which may be activated by changing fluid temperatures in the faucet 97. Adjustment may also or instead be caused by the SMA being electronically coupled to or activated by a current (e.g., from a low voltage power source like a battery pack).

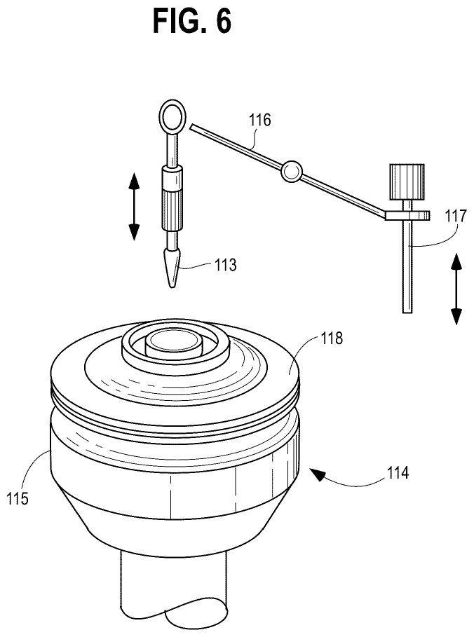

In FIG. 6, a faucet (or other water outlet, like a toilet fill valve, for example) may include a pin 113 which may control flow into and through a ball valve 114. The ball valve 114 may be opened and/or closed via the SMAs to cause the faucet to turn on and/or off. The ball valve 114 may be a miniature valve, and the ball valve 114 may be designed similar to ball valves known in the art. An SMA may be incorporated in a diaphragm of the ball valve 114, which may reduce a size of the ball valve 114. The SMAs used with the ball valve 114 may create reciprocating action, including in linear/non-linear motion, that when coupled with other materials, can create a fluidic pumping action. Such actions may be used for chemical dosing to toilets, drains, etc. Dosing may be triggered by warm water engaging with the pump; when engaged, the pump may dose the chemical. The pumps can be operated by applying an electrical current to the SMAs.

The ball valve 114 may include a valve body 115, which may interact with the pin 113. The pin 113 may be attached to an arm 116 of a float 117. The pin 113 may be formed by an SMA, such that the pin 113 may change shape and/or size to control the valve without requiring movement of the float 117 or other mechanisms. The pin 113 may take different positions such that, in a first position, the pin 113 may allow fluid to pass while, in a second position, the pin 113 may not allow fluid to pass. The pin 113 may be similar to a restricting pin used in the art, and the pin 113 may be positioned within a hole in the ball valve 114. The arm 116 may be made from or may be actuated by an SMA, and the arm 116 may be used alongside or in place of an SMA-activated pin 113. A main seal 118 may form a seal between the pin 113 and the valve body 115. The main seal 118 may have SMA wires or rods or a plate or disk, each which may be configured to adjust in shape (i.e., between a dome shape and a conical shape).

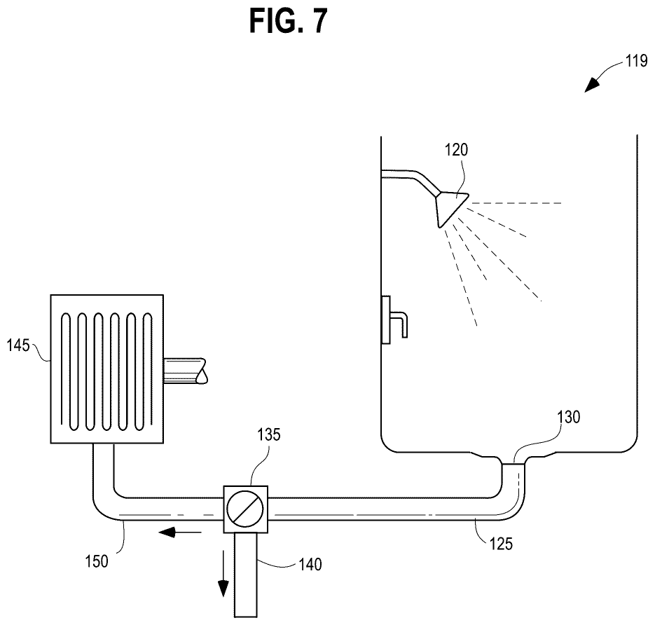

Turning now to FIG. 7, SMAs may be used in a shower system 119. A showerhead 120 may output hot/warm water and/or cold water, which may be fed into pipe 125 at drain 130. Such water may be diverted at an SMA diverter valve 135. The SMA diverter valve 135 may direct cold water downward via cold water pipe 140. The SMA diverter valve 135 may direct hot/warm water to a heat recovery system 145 via hot/warm water pipe 150. The heat recovery system 145 may be configured to recover heat from the hot/warm water, and such system 145 may be any heat recovery system now known or hereafter developed. The SMA diverters as discussed herein may further be used to switch paths of water. For example, SMA diverters may be used to direct cold water from the tub spout until it gets warm. Once it reaches a predetermined temperature, the SMA diverters may cause the water to redirect from the tub spout, for example, toward the shower head. Such diversion may serve as an indication to a user that the water has reached the predetermined temperature desired by the user. Using SMAs, rather than motors, cylinders, servos, etc., may be advantageous, as SMAs may be more resilient to water and chemicals in showers (unlike electronics) and may be more longevity.

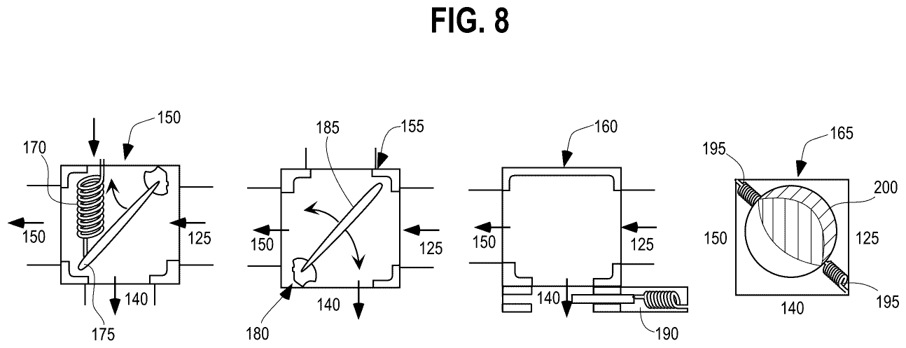

The SMA diverter valve 135 of FIG. 7 may take many forms, including those as shown in FIG. 8 as valves 150, 155, 160, and 165. Valve 150 may include an SMA coil 170 attached to a diverter 175. Depending on the temperature of water coming into the valve 150, which may be directed from pipe 125 of FIG. 7, the SMA coil 170 may expand or retract. When expanded, the SMA coil 170 may push the diverter 175 downward, causing the water to be directed in a downward direction; the downward direction may be into cold water pipe 140 of FIG. 7. When retracted, the SMA coil 170 may pull the diverter 175 upward, which may cause the water to flow outward via a water pipe, which may be water pipe 150 of FIG. 7. The positioning of the diverter 175 may cause one pipe to be closed off, while another pipe is opened for water flow.

Valve 155 may include an SMA torsion spring 180 attached to a diverter 185. Depending on the temperature of water coming into the valve 155, which may be directed from pipe 125 of FIG. 7, the SMA torsion spring 180 cause the diverter 185 to move. The SMA torsion spring 180 may cause the diverter 185 to move upward, causing the water to be directed in a downward direction; the downward direction may be into cold water pipe 140 of FIG. 7. The SMA torsion spring 180 may cause the diverter 185 to move downward, which may cause the water to flow outward via a water pipe, which may be water pipe 150 of FIG. 7. The positioning of the diverter 185 may cause one pipe to be closed off, while another pipe is opened for water flow.

Valve 160 may include an SMA sliding gate valve 190 which may be configured to adjust to close of a water pipe. For example, the SMA sliding gate valve 190 may close off water pipe 140; when this is done, the water may be directed out toward water pipe 150. Valve 165 may include two SMA torsion springs 195 attached to a ball valve 200. The SMA torsion springs 195 may be configured to rotate the ball valve 200 in order to close off and/or open water pipes in order to direct flow of the water. For example, the water pipes 140 and/or 150 of FIG. 7 may be closed off and/or opened up depending on the temperature of the water being directed into the ball valve 200 from water pipe 125.

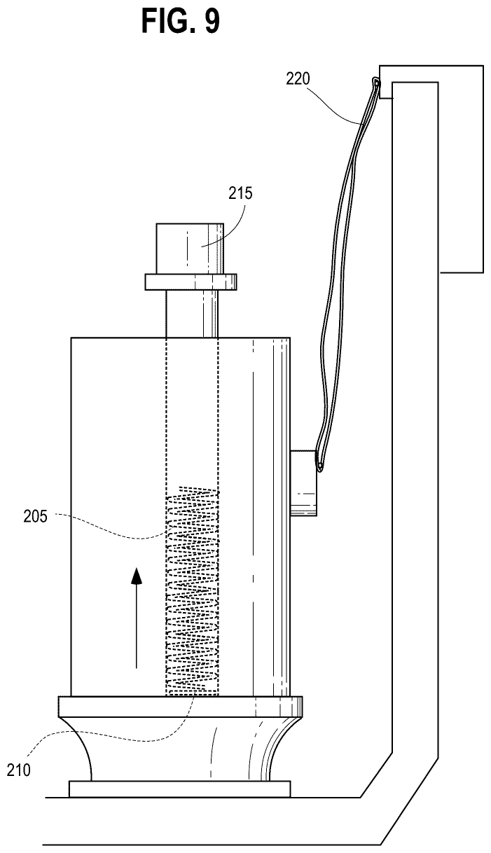

FIGS. 9-28 illustrate different uses of SMAs in the toileting industry. SMAs may be used to eliminate or reduce the use of motors and/or pneumatic and hydraulic cylinders in toilets. SMAs may be small enough to fit within a trip lever handle of the toilet. SMAs may reduce the size and/or footprint of actuators in the toilets.

In FIG. 9, an SMA spring 205 may be fitted in order to open or close a valve 210. The valve 210 may be a toilet flush valve, for example. The use of the SMA spring 205 may allow for a reduction and/or elimination of the traditional “float” portion of a valve. The valve 210 may be adjusted using a button or dial 215. In the same location as the button or dial 215, a connection point may be provided. The connection point may be configured to supply refill water from a refill tank to a toilet bowl, such that the toilet bowl may be refilled after it has been flushed. In addition to applying an electrical current to the SMA spring 205, the system may direct hot water through and into the connection port. After the float valve lifts, cold water from the refill tank may enter the toilet bowl. The cold water may reach the SMA spring 205 and may cool the SMA spring 205, which may cause the SMA spring 205 to retract. Such retraction may cause the float valve to return to a seated position which may reseal the refill tank, which may allow it to be re-filled. The SMA spring 205 and/or button 215 may be configured to lift an SMA loop 220. The SMA loop 220 may be used to lift a float valve.

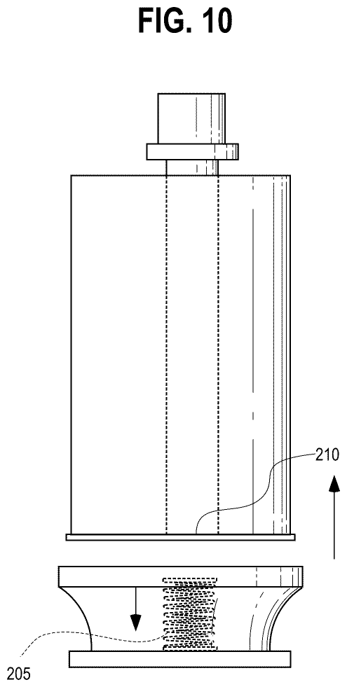

In FIG. 10, the SMA spring 205 may be used to lift a float valve off of a float valve seat. Once the float valve is lifted, the float valve may be kept open for a predetermined time using buoyancy. Additionally or alternatively, a user may lift the float valve manually via a trip lever. In such an instance, the aforementioned SMA components may not interfere with such manual actuation. As illustrated, the SMA may directly or indirectly actuate a toilet valve. The SMA may be assembled in various ways with the toilet valve in order to create a lifting action based on a state of the SMA. Cold water may activate the SMA to cause motion, or the cold water may deactivate the SMA to prevent motion. Hot water, heat, or other sources may activate the SMA to cause motion, or such sources may deactivate the SMA to prevent motion.

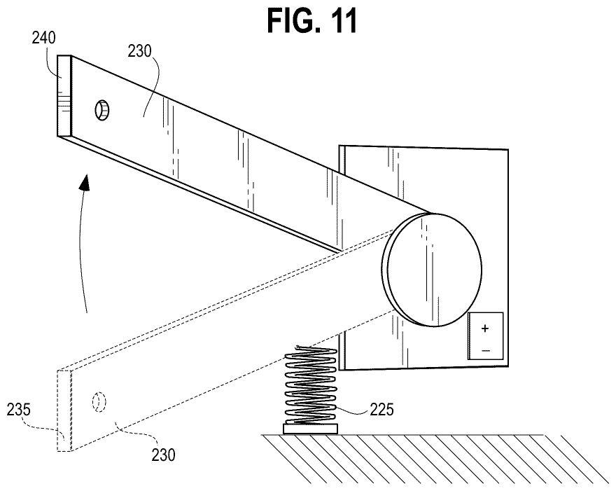

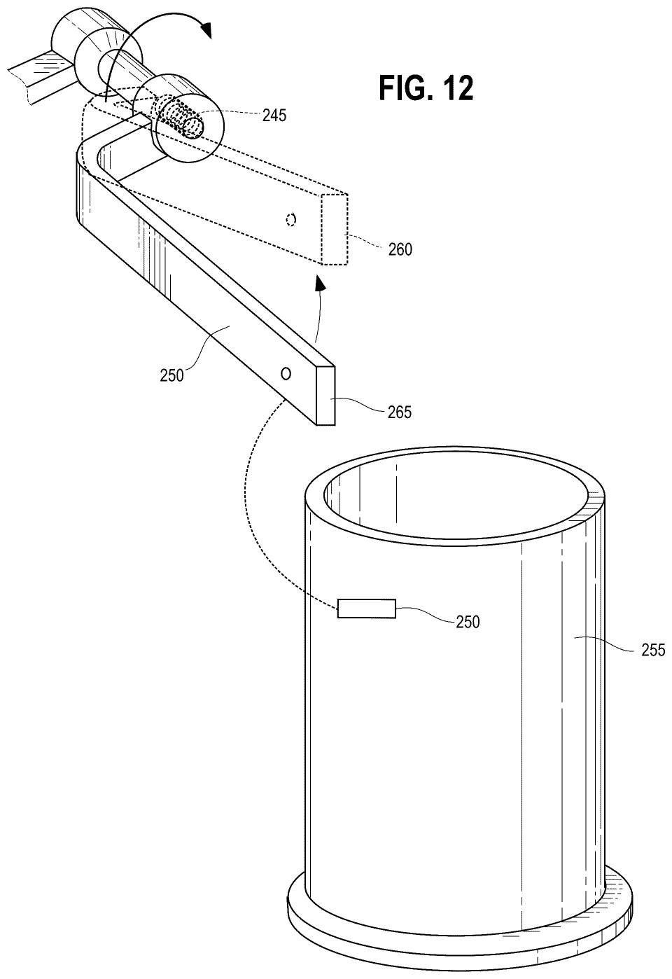

According to FIG. 11, an SMA lift 225 may be attached to an arm 230. The SMA lift 225 may be configured to adjust the arm 230 between a first position 235 and a second position 240. The SMA lift 225 may be an SMA mechanism integrated into a traditional handle and arm assembly of a toilet, for example. The system illustrated in FIG. 11 may include a trip lever on an outside of the toilet assembly, which may be coupled to the arm 230. The arm 230 may be adjusted using traditional means (i.e., through the trip lever) or may be actuated through activation of the SMA and/or an electrical current fed through the SMA. The SMA lift 225 (and corresponding system of FIG. 11) may be used to actuate a toilet flush, which may be achieved using electronic and/or battery-powered means. The system may include a coil spring, as illustrated in FIG. 11. The system may also or instead use other spring types, including torsion springs. As shown in FIG. 12, an SMA torsion spring 245 may be attached to a toilet handle 250 attached to a toilet 255. The SMA torsion spring 245 may be configured to adjust (or rotate) the handle 250 between a first position 260 and a second position 265.

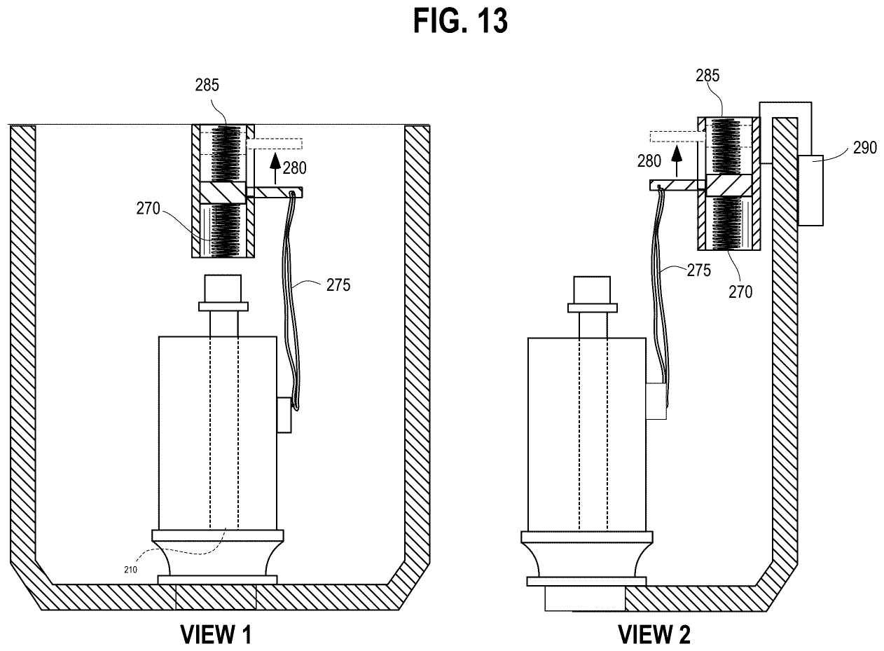

According to FIG. 13, an SMA 270 may expand when it is energized. Such expanding may cause a wire 275 to move in an upward direction, as shown by arrow 280. A control spring 285 may be positioned above the SMA 270 and may cause an arm to reset. In addition to, or alternatively, a battery control 290 may cause such movement of the wire 275. The system illustrated in FIG. 13 may be used to open a canister/flapper flush valve (the system may be external to the flush valve). An attachment point of the system may be attached or connected to the valve and may move up and down, causing the valve to adjust. The system may be enabled with push-button flushing, which may promote accessibility, as less pressure may be needed to flush the toilet, for example. The system may or may not include a trip lever arm, as the system may be activated using a touchless sensor or push button; as illustrated in FIG. 13, the system does not include a trip lever arm.

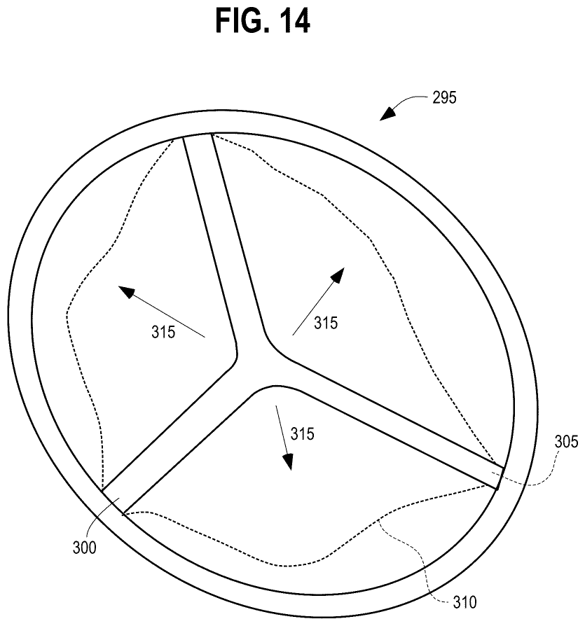

New types of diverter and/or control valves may be used to eliminate or reduce air from jet channels in toilets. These valves may mimic the mechanics and configurations of mechanical heart valves. The valves may be used as a flush valve, as in FIG. 14. A valve 295 may be inserted into toilet water channels, and the valve 295 may be controlled to close and/or open such channels. SMA wires 300 may be activated to take on different shapes and configurations. SMA wires 300 may move from a first configuration 305 to a second configuration 310 via movement as shown at arrows 315.

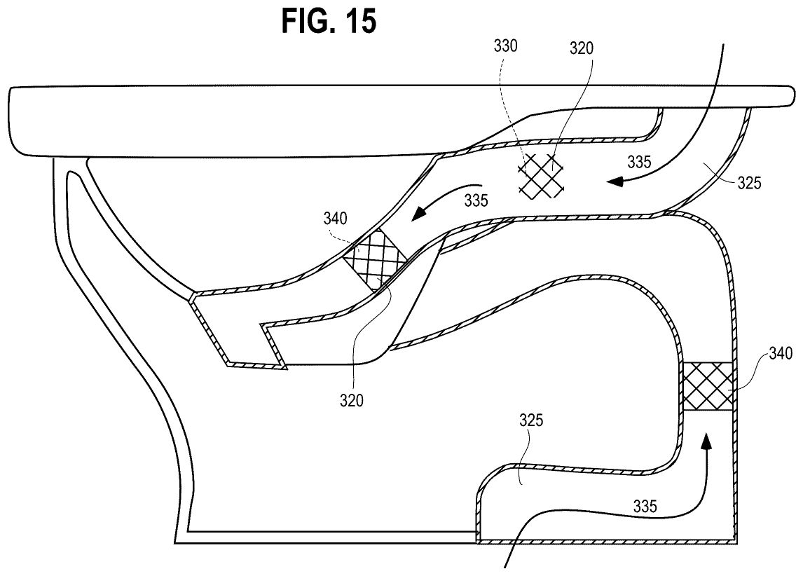

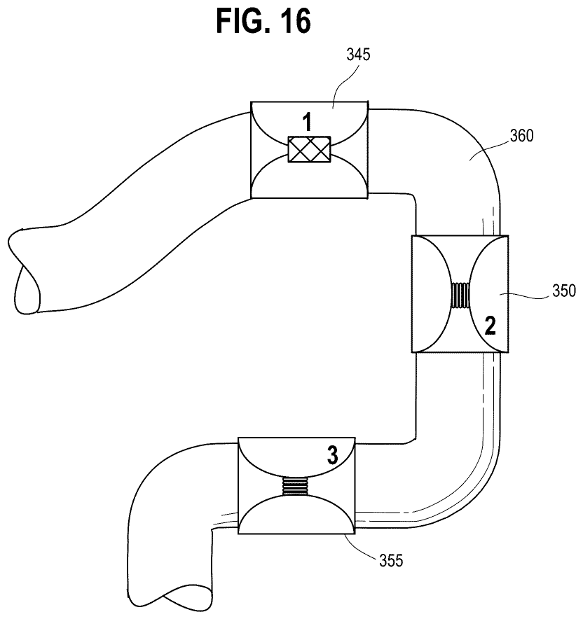

Flush engines may be developed using SMA valves in the trap of a toilet. SMA valves may be used for pre-priming the trap of a toilet, as shown in FIG. 15. The expanding SMA valve 320 may be inserted into a trap of a toilet in a compact state 330. The valve 320 may move within the trap 325 via arrows 335 and may expand into an expanded state 340. SMA valves may be used for creating a peristaltic-like action in the trap of a toilet, as shown in FIG. 16. The valves 345, 350, and 355 may be inserted into the trap 360 of the toilet. The valve 345 may be NiTi mesh, a coil spring, or any other valve that may be used to close. Valve 345 may open first, then valve 350 may open, then valve 355 may open last. Such sequence may creation a vacuum action within the trap 360 of the toilet.

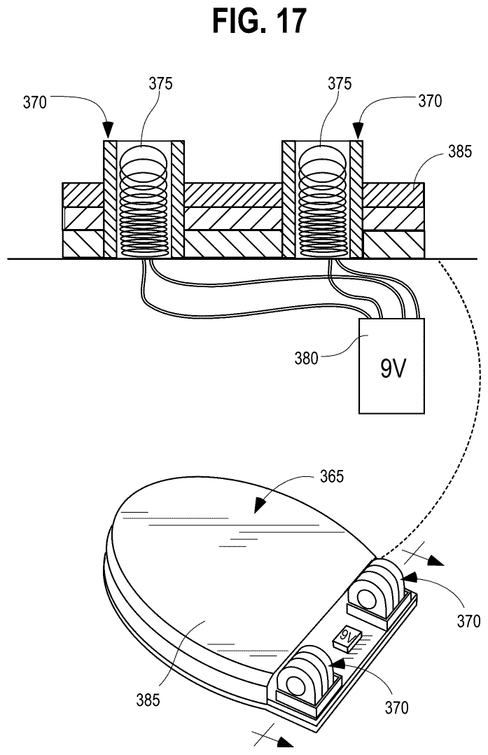

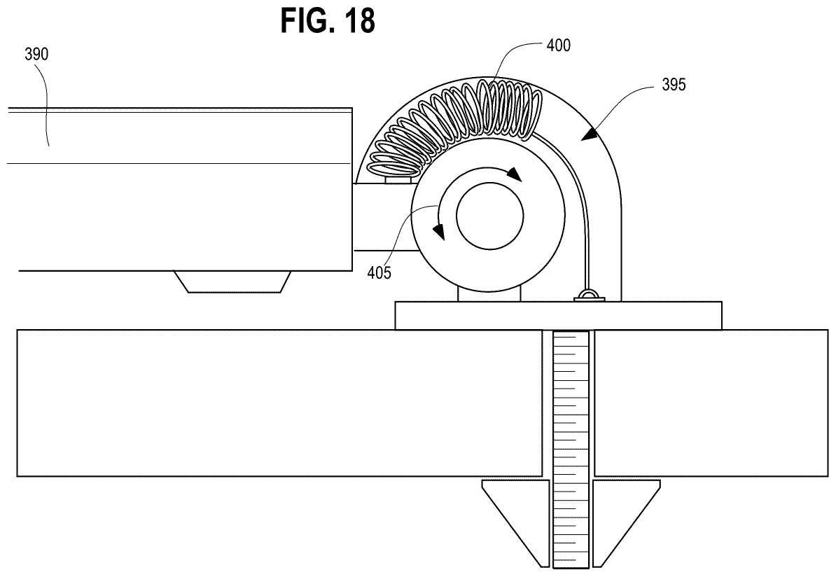

Further in the toileting industry, motors, solenoids, and actuators may be replaced with SMA coils, springs, rods, wires, etc. SMAs typically have high tensile strength, even at very small diameter and/or gauge thicknesses. For example, SMAs may be used to auto open and close toilet seats. Use of SMAs, instead of motors and gears, may be less expensive and may be more resistant to chemicals. Further, SMAs may include a desirable soft-close feature when the coil, torsion, or helical spring is used to act as the actuator. As shown in FIG. 17, a toilet seat 365 may include hinges 370. The hinges 370 may include SMA springs 375, which may be attached to a battery 380. The battery 380 may be configured to activate the SMA springs 375 in order to open and/or close the toilet seat 385. Turning to FIG. 18, a toilet seat 390 may be attached to a hinge 395 to open and/or close the toilet seat 390. The hinge 395 may include an SMA spring 400 which may be activated in order to open and/or close the toilet seat 390 (via rotation according to arrow 405).

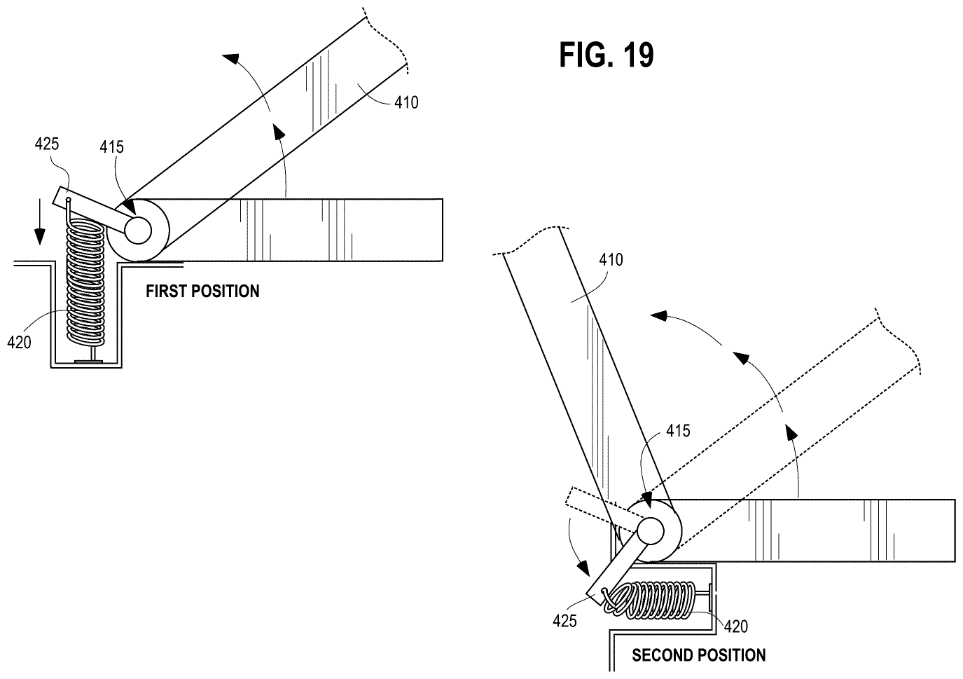

According to FIG. 19, a toilet seat 410 may be opened and/or closed via a hinge 415. The hinge 415 may be attached to SMA spring 420. When SMA spring 420 is retracted, the SMA spring 420 may pull down on a hinge lever 425, which may cause the toilet seat 410 to raise to be opened. When SMA spring 420 is expanded, the SMA spring 420 may push up on a hinge lever 425, which may cause the toilet seat 410 to lower to be closed.

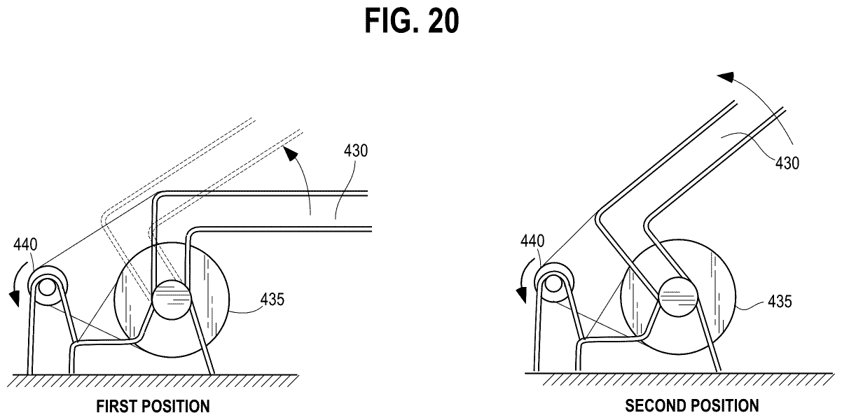

As shown in FIG. 20, a toilet seat 430 may be attached to a pulley system 435. The pulley system 435 may be attached to a SMA wire 440 configured to contract. When the SMA wire 440 contracts, the pulley system 435 may cause the toilet seat 430 to be raised. When the SMA wire 440 expands, the pulley system 435 may cause the toilet seat 430 to be lowered. The SMA wire 440 may be wound along a cylinder-like pulley 435, as shown in FIG. 21. Being wound in such a configuration may increase the pulley's range of motion.

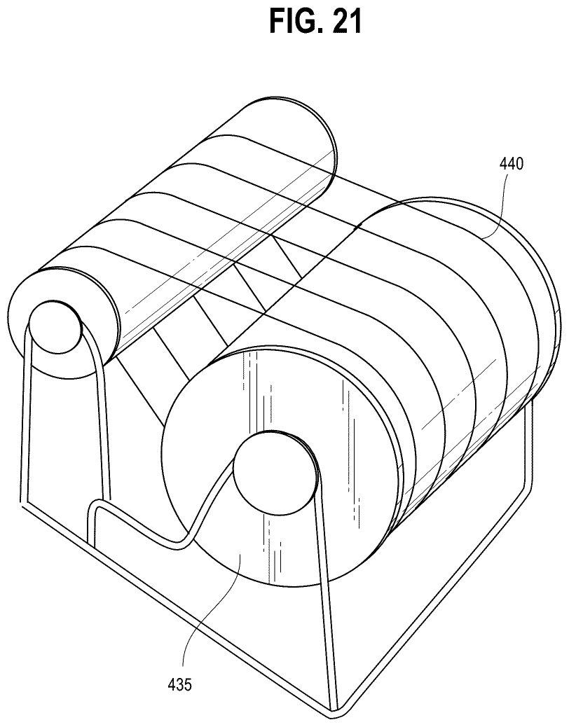

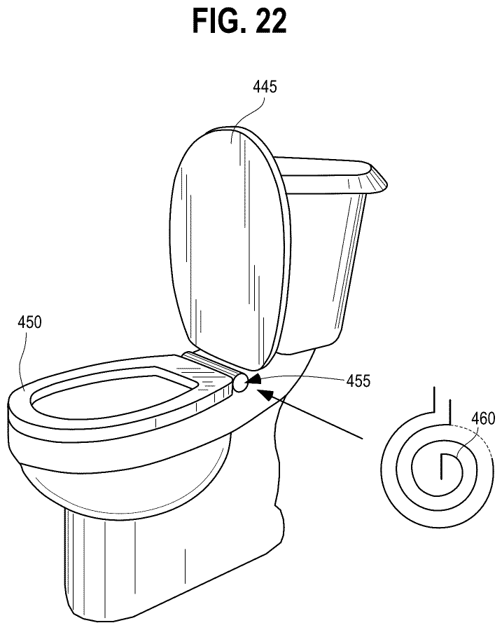

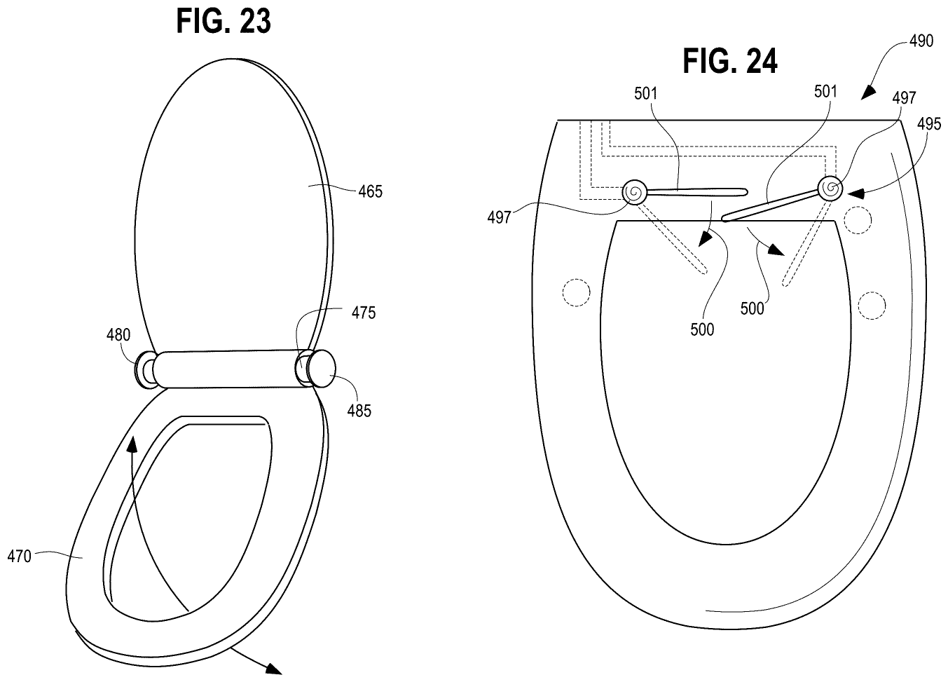

Turning to FIG. 22, a toilet seat lid 445 and toilet seat 450 may be attached to a hinge 455. The hinge 455 may include a SMA torsion spring 460, which may be activated to cause the toilet set lid 445 and/or the toilet seat 450 to be opened and/or closed. As shown in FIG. 23, a toilet seat lid 465 and toilet seat 470 may be attached via a hinge 475. The hinge 475 may include an SMA configured to raise and/or lower the toilet seat lid 465 and/or the toilet seat 470. To lower the toilet seat lid 465 and/or the toilet seat 470, a user may press a button 480. To raise the toilet seat lid 465 and/or the toilet seat 470, a user may press a button 485. According to FIG. 24, a toilet seat 490 may be attached to a bidet system 495. The bidet system 495 may be attached to an SMA torsion spring 497, such that when water is warm, the bidet system 495 extends in the direction as shown by arrow 500 for use. The bidet system 495 may include two arm portions 501, which may extend based on the temperature of water passing through the SMA torsion spring 497 and/or power supplied to the SMA torsion spring 497.

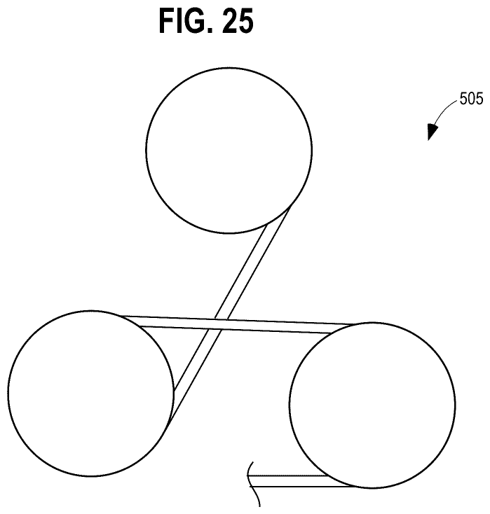

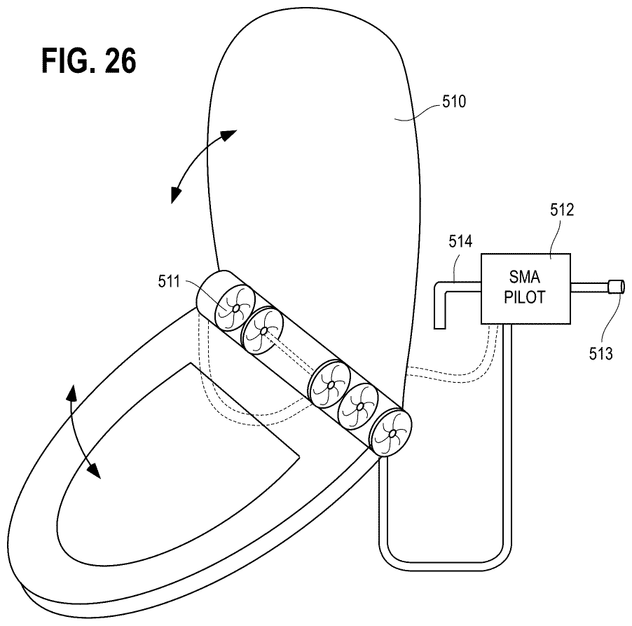

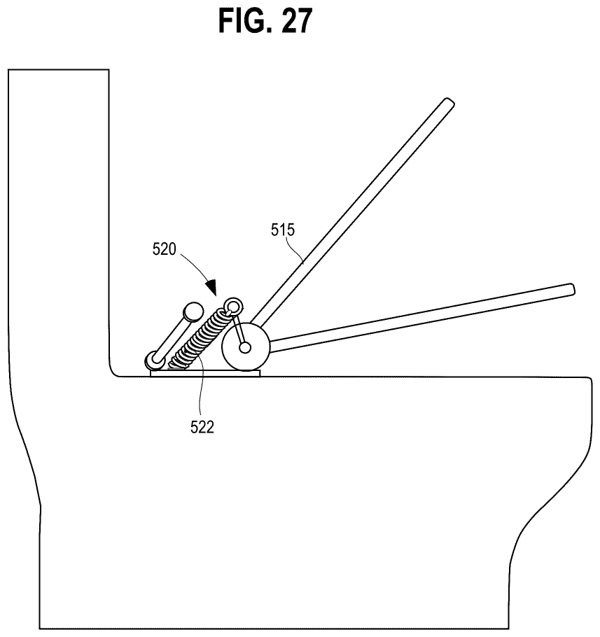

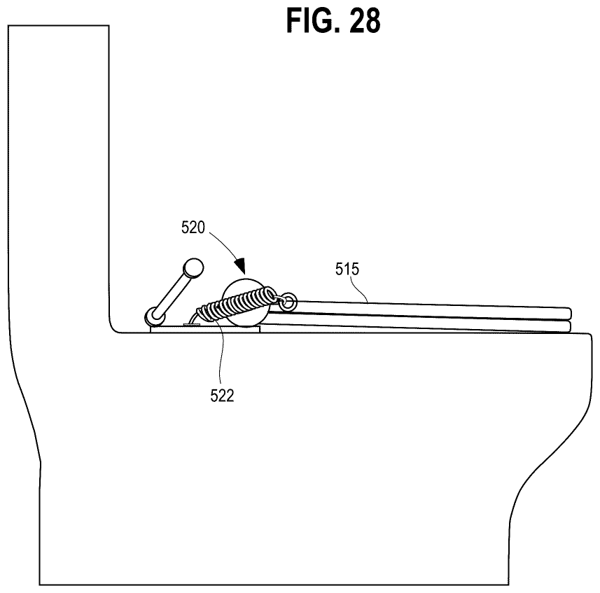

The toilet seats as discussed herein may further be attached to a pulley system 505, as shown in FIG. 25, in order to raise and/or lower toilet seats and lids. In FIG. 26, a toilet seat 510 may be water driven, and a water valve may be configured to raise and/or lower the toilet seat 510. The toilet seat 510 may be attached to or integrally formed with turbine actuators 511. The turbine actuators 511 may be coupled to an SMA pilot 512, which may be connected to a supply 513 and a toilet refill 514, for example. The water flowing through the SMA pilot 512 may cause the turbine actuators 511 to adjust, based on the temperature of the water. In FIG. 27, a toilet seat 515 may be opened due to a spring driven linkage 520. The spring driven linkage 520 may include an SMA spring 522, which may be configured to raise and/or lower the toilet seat 515. When lowered, as shown in FIG. 28, the toilet seat 515 may be closed due to movement caused by the spring driven linkage 520. The toilet seat 515 may lower via gravity once the spring driven linkage 520 is deactivated. The electrical current and/or fluid temperature passing through the SMA spring 522, which may cause the SMA spring 522 to activate and/or return to an original state. The spring driven linkage 520 may incorporate different assemblies (e.g., torsion spring, helical spring, mechanical assembly) together to achieve motion of a toilet seat lid, for example.

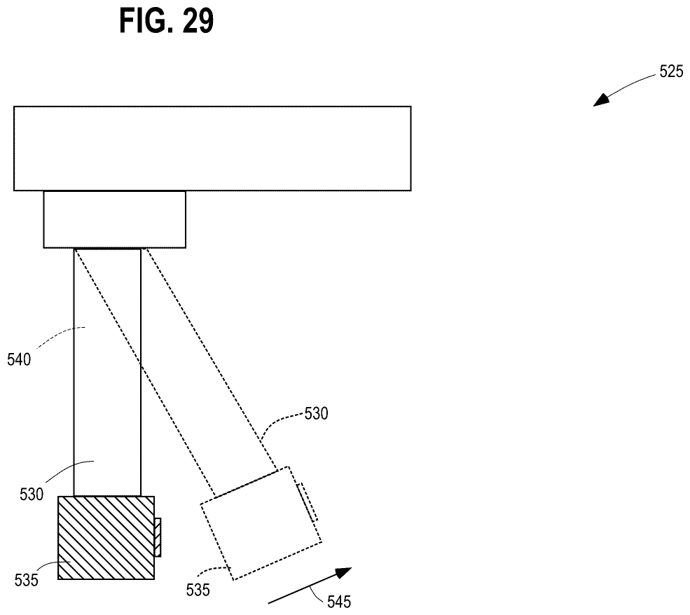

SMAs may also be used to extend and/or oscillate bidet wands. Any desirable SMAs may be used, including helical SMA springs, pulleys with SMA cables, SMAs attached to low voltage power sources, etc. According to FIG. 29, a bidet wand 525 may include a hose 530 and/or a spray tip 535. The bidet wand 525 may furth include an internal SMA wire 540. When the SMA wire 540 is shortened, the bidet wand 525 may be raised and moved in a direction shown by arrow 545. Such movement may give the bidet wand 525 directional control. The SMA wire 540 may be designed as a loop, such that it can extend and/or retract (based on temperature changes and/or electrical current, for example) in length enough to achieve motion and/or actuation, even without mechanical gearings or linkages. Using the SMA wire 540 for a linear pull action may aid in achieving high actuation force, which may be a higher force than an SMA coil spring.

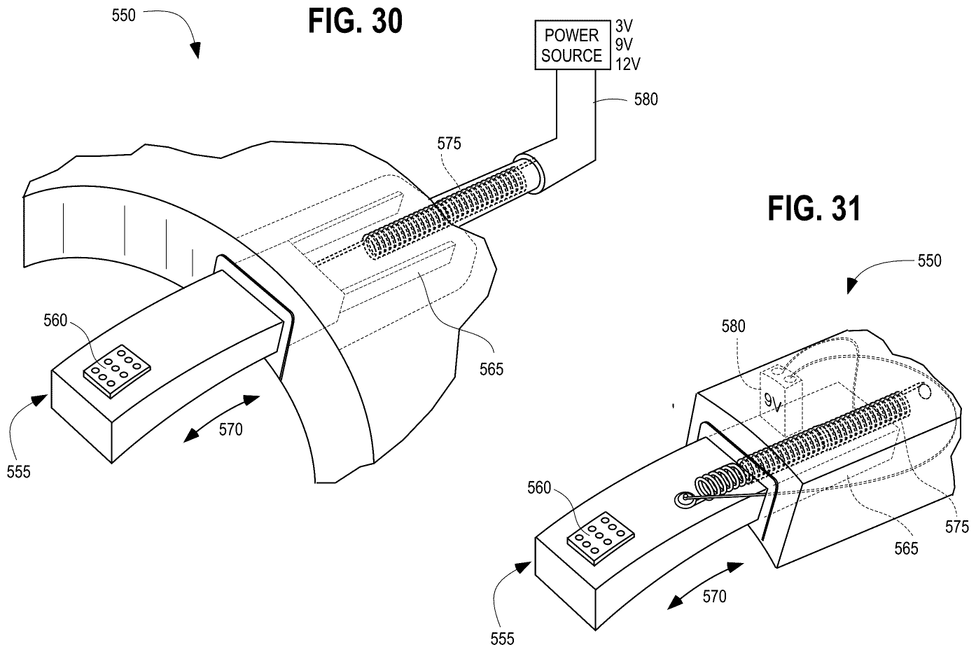

As shown in FIGS. 30 and 31, a bidet wand 550 may include a spray portion 555, which may include a spray nozzle 560. The spray portion 555 may extend outward from the bidet holder 565 when a user wants to use the spray nozzle 560. When the bidet wand 550 is not being used, the spray portion 555 may be received within the bidet holder 565. The spray portion 555 may move in a direction as shown by arrow 570 to extend outward and may move in the opposite direction in order to be received within the bidet holder 565. Such movement may be achieved via SMA spring 575. SMA spring 575 may be activated via a water source depending on temperature of the water and/or via power source 580. Power source 580 may be a 3V, 9V, or 12V battery, or any other power source now known or hereafter developed. The SMA spring 575 may be retracted and/or expanded based on the water source and/or the power source 580. Additionally or alternatively, actuation of the SMA spring 575 may be activated by heated water applied to the SMA spring 575. When heated water is applied to the SMA spring 575, the SMA spring 575 may expand. When heated water is no longer applied and the SMA spring 575 has cooled, the SMA spring 575 may retract. A secondary spring may be used in addition to the SMA spring 575 to increase the speed of retraction.

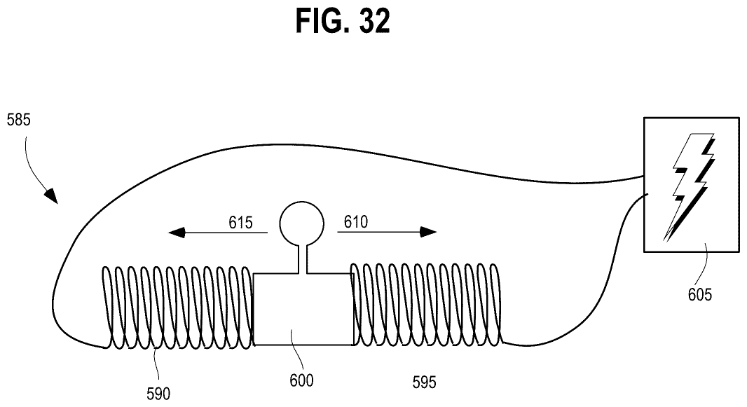

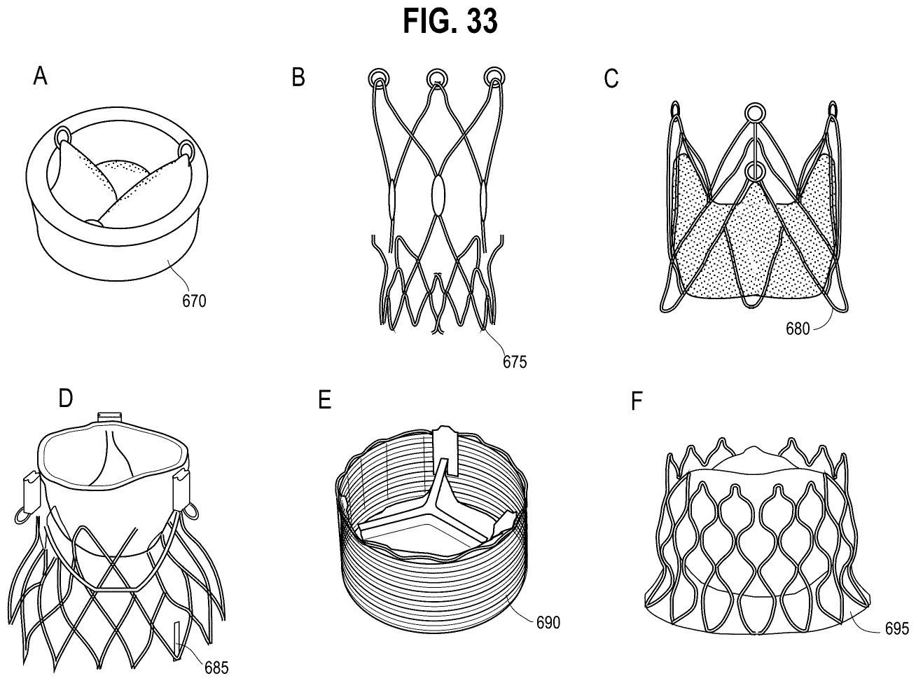

When the SMA spring 575 is retracted, the spray portion 555 may be contained and received within the bidet holder 565. When the SMA spring 575 is expanded, the spray portion 555 may extend outward from the bidet holder 565, such that the spray nozzle 560 is accessible and may be used. In FIG. 32, an SMA spring 585 may include a first portion 590 and a second portion 595. The first portion 590 and second portion 595 may be connected via a shuttle 600. The shuttle 600 may be activated via a power source 605. The power source 605 may cause the shuttle 600 to move in direction 610, which may cause the first portion 590 to be expanded while the second portion 595 is retracted. The power source 605 may cause the shuttle 600 to move in direction 615, which may cause the first portion 590 to be retracted while the second portion 595 is expanded.

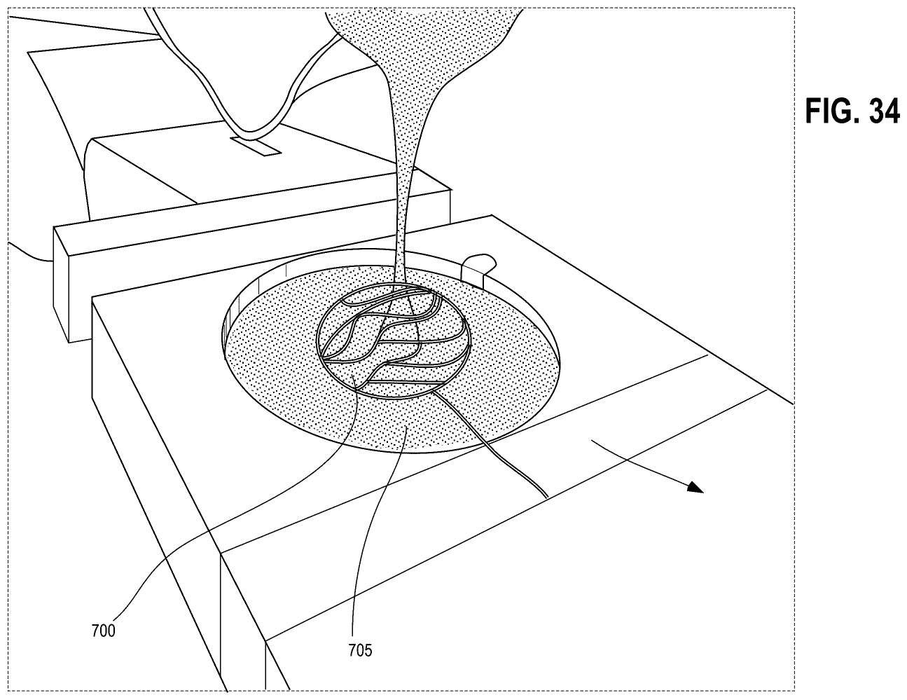

Turning now to FIG. 33, the SMAs may replace valves in fixtures, including in toilets as discussed above. Such SMAs may take on forms similar to human heart valves, as shown in 670, 675, 680, 685, 690, and 695. Such valves may be installed in confined spaces within vitreous fixtures. Such fixtures may have no solution without these SMAs for installing a valve at a desired location. For example, the expanding valve (using an SMA) may be made to fit inside the jet channel or inlet of a toilet. This may improve performance by retaining water and eliminating air from the jet channel and inlet of a toilet.

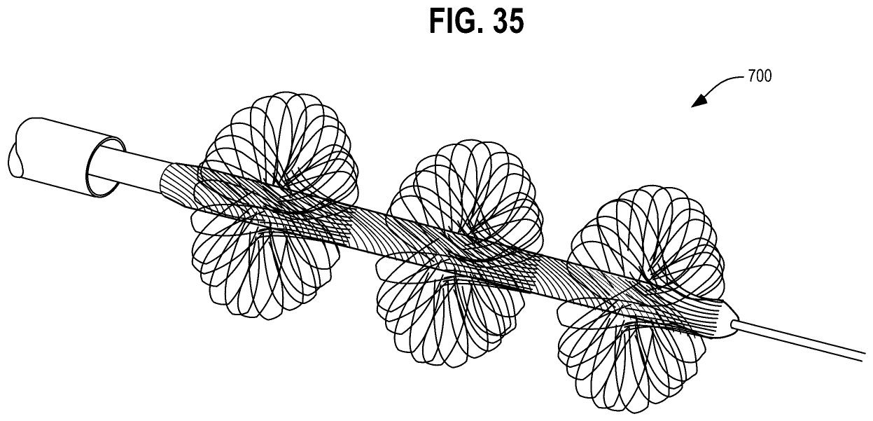

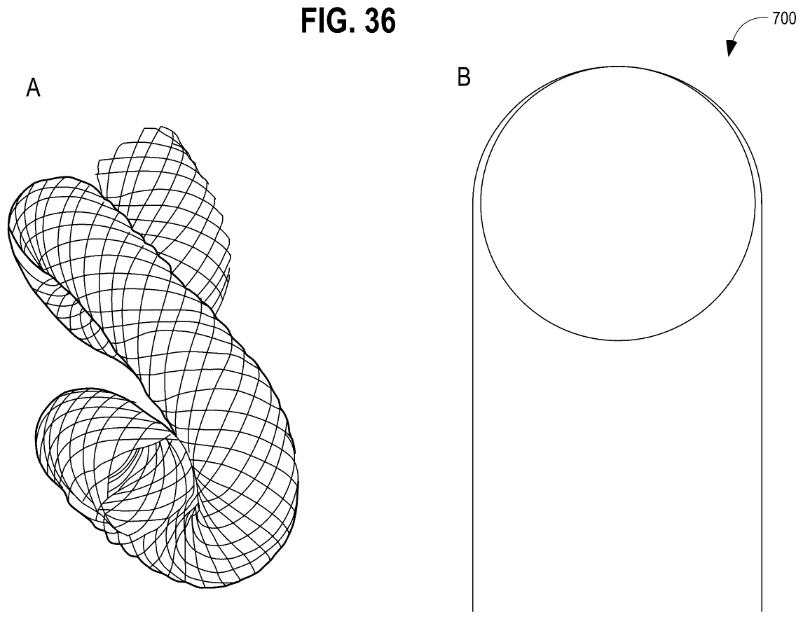

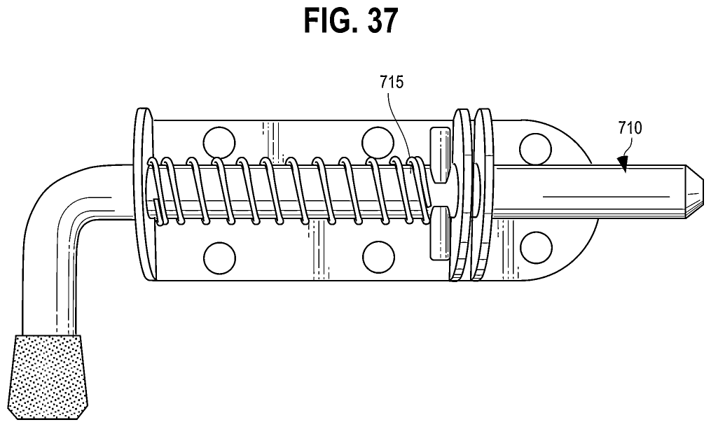

According to FIG. 34, clay casting may be used to develop an SMA structure 700. Cavities may be created to be more shape specific in such a manner. The SMA structure 700 may be a wire mash and may be contained within an expandable sealed sheath (e.g., latex, rubber, neoprene, etc.). The clay body 705 may cast up and around the SMA structure 700 with the sheath in its expanded form. When the SMA structure 700 needs to be removed, the SMA structure 700 may be collapsed, and the clay body may remain intact. SMA structure 700 and clay body 705 may be used to create voids and/or passageways inside clay or vitreous product. The SMA structure 700 may take on many different shapes when made with the clay casting, as shown in FIGS. 35 and 36, and may be covered with an impermeable flexible outer material (e.g., latex).

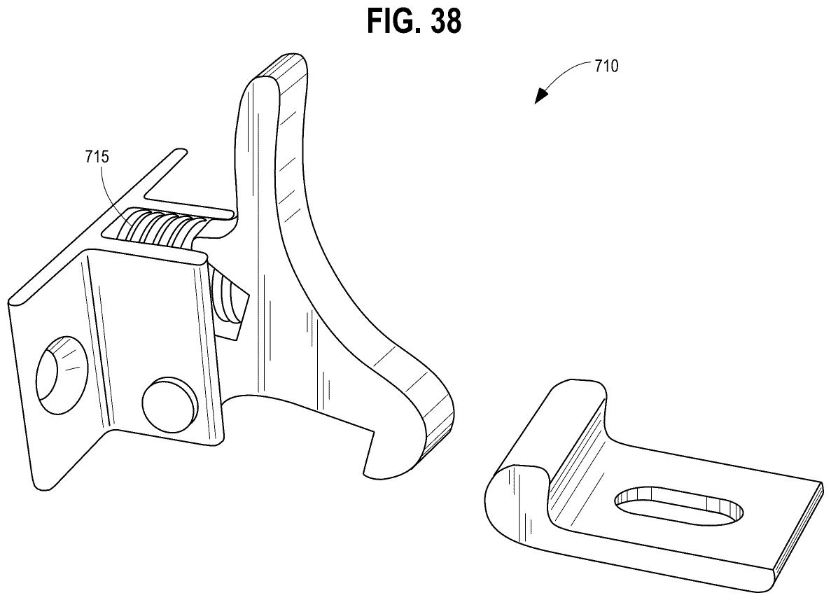

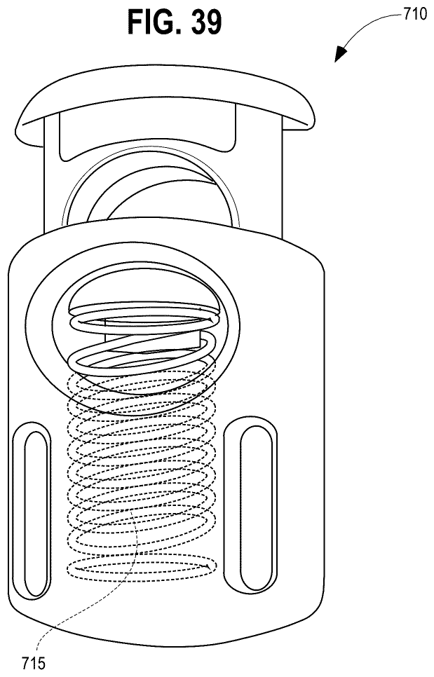

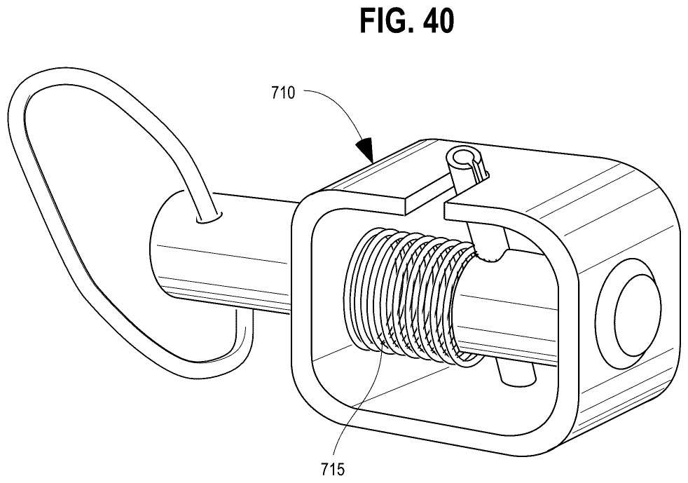

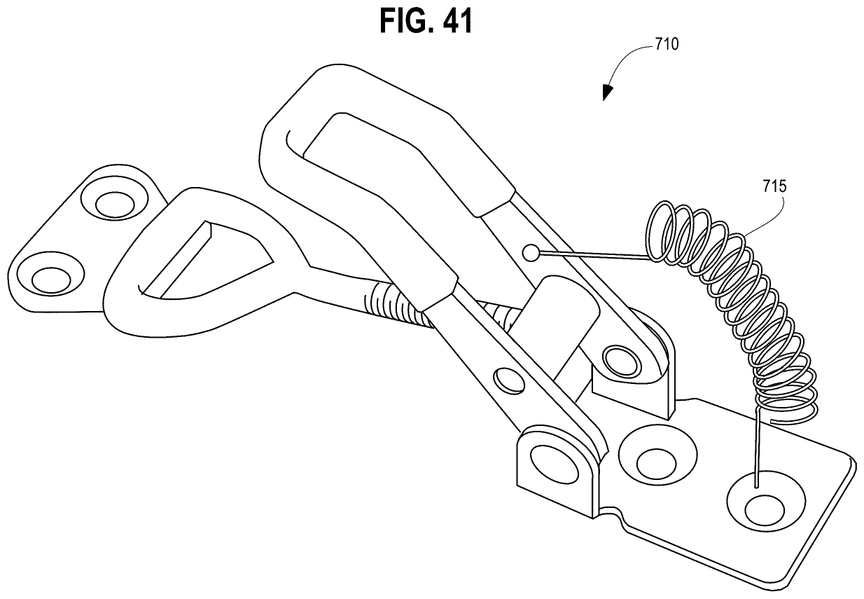

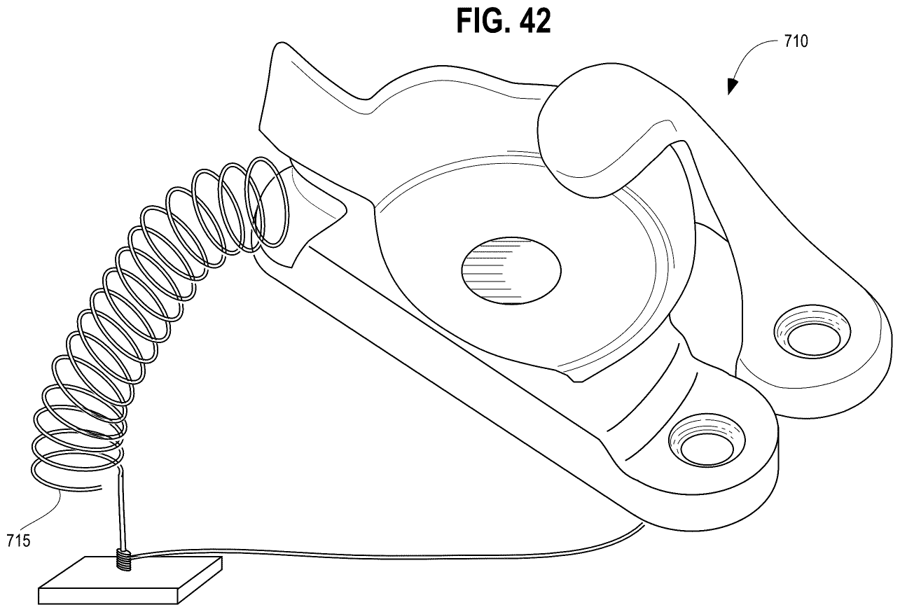

FIGS. 37-42 illustrate different installation and attachment methods for the SMAs. The SMAs may be self-affixing, such that the SMA spring loads a pin for installation but can be retracted (using an electrical current) for easy removal. This could also be done in reverse, where the pin may not extend until the SMA is energized via the electrical current. The SMAs may be mounted via cam and pin locks. Cam, pin, and rotational locking mechanisms known in the art traditionally use coil springs; however, such coil springs could be replaced with SMA springs to add the electronic control. This may be particularly useful in tight spaces. Such a lock may be actuated via a battery and may be installed virtually anywhere. The SMAs may have escutcheon installation possibilities (e.g., via grab bars with hidden set screws). The set screws or set pins may have small torsion coils that sets such mechanism. The SMAs may have drain installation possibilities. The installation may occur through a rotating or locking flange with an SMA actuator. As shown in FIGS. 37-42, the locking and latching assemblies 710 may be fitted via an SMA spring or coil 715 in order to create a temperature-dependent or electronically activated locking or installation system.

The SMAs as described herein may be used in variable pitch propellers (e.g., bath pumps). SMAs may be used in jetted bathtubs, whirlpool tubs, or bubble tubs. SMAs may be useful, in place of or in addition to propellers or impellers, as they may be adjusted based on the temperature of the fluid surrounding them.

The SMAs as described herein may be used with detection and/or occupancy sensors. Body heat could trigger an action (e.g., presence in a room) which may provide input to an electronic system which may indicate occupancy of a room. Current systems may use RFID to determine occupancy; SMAs may replace or be used in addition to RFID equipment. For example, a small SMA switch may be built into a toilet seat to detect when the stall is being used and/or when a toilet needs to be flushed.

Any number of the foregoing components and configurations may be connected and used together. As one example, a toilet may include a solid-state-like design of a control with SMAs incorporated therein. The control may include a feed and a return, such that water may flow into and through the control. The control may be configured to cause the toilet seat to open and/or close a toilet seat, open and/or close a toilet seat ring, and/or extend the bidet system out for use. The foregoing shall not be construed as limiting, and any number of configurations and adjustments may be made as desired.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A bathing fixture comprising:
a base portion;
a movable portion configured for selective movement relative to the base portion;
a shape memory alloy portion positioned between the base portion and the movable portion, the shape memory alloy portion engaged with the movable portion to adjust a position of the movable portion when the shape memory alloy portion is activated by at least one of the following:
a temperature change; and
an electrical current.

2. The bathing fixture of claim 1, further comprising a water supply.

3. The bathing fixture of claim 2, wherein a first temperature of water flowing through the water supply along the shape memory alloy portion corresponds to a first position of the shape memory alloy portion, and wherein a second temperature of water flowing through the water supply along the shape memory alloy portion corresponds to a second position of the shape memory alloy portion.

4. The bathing fixture of claim 1, wherein the bathing fixture is at least one of a faucet, a toilet, and a bidet wand.

5. The bathing fixture of claim 4, wherein the bathing fixture is a faucet.

6. The bathing fixture of claim 4, the bathing fixture is a toilet, wherein the base portion is a bowl of the toilet, and wherein the movable portion is a seat of the toilet.

7. The bathing fixture of claim 4, wherein adjustment of the shape memory alloy portion causes a bidet wand to extend to a position for use.

8. A self-affixing fixture comprising:
an assembly, wherein the assembly is one of an installation assembly, a locking assembly, or a latching assembly;
a shape memory alloy portion engaged with the assembly, wherein the shape memory alloy portion is configured to adjust a position of the assembly when the shape memory alloy portion is activated by at least one of the following:
a temperature change; and
an electrical current.

9. The self-affixing fixture of claim 8, wherein the assembly further comprises a pin.

10. The self-affixing fixture of claim 9, wherein the shape memory alloy portion is a spring loaded on the pin.

11. The self-affixing fixture of claim 8, further comprising a detection sensor, and wherein the detection sensor causes the shape memory alloy portion to adjust.

12. The self-affixing fixture of claim 9, wherein the pin comprises one or more torsion coils.

13. The self-affixing fixture of claim 9, wherein the assembly is installed in a drain.

14. The self-affixing fixture of claim 13, wherein the temperature change is caused by a temperature of water flowing through the shape memory alloy portion.

15. A shape memory alloy system comprising:
a shape memory alloy portion engaged with a bathing fixture, wherein the shape memory alloy portion is configured to adjust a position of a portion of the bathing fixture when the shape memory alloy portion is activated by at least one of the following:
a temperature change; and
an electrical current.

16. The shape memory alloy system of claim 15, wherein the bathing fixture is at least one of a faucet, a toilet, and a bidet wand.

17. The shape memory alloy system of claim 15, further comprising a water supply.

18. The shape memory alloy system of claim 17, wherein a first temperature of water flowing through the water supply along the shape memory alloy portion corresponds to a first position of the shape memory alloy portion, and wherein a second temperature of water flowing through the water supply along the shape memory alloy portion corresponds to a second position of the shape memory alloy portion.

19. The shape memory alloy system of claim 18, wherein the first position of the shape memory alloy portion corresponds to a first position of the portion of the bathing fixture, and wherein the second position of the shape memory alloy portion corresponds to a second position of the portion of the bathing fixture.

20. The shape memory alloy system of claim 15, wherein the shape memory alloy portion is formed as at least one of a rod, coil, wire, spring, plate, foil, sheet, extrusion, stamping, and mesh.
